(19) United States
(12) Patent Application Publication
(10) Pub. No.: US 2002/0080200 A1
(43) Pub. Date: Jun. 27, 2002

(54) Method and apparatus for implementing a web application

(76) Inventors: Garland Wong, Rancho Santa Fe, CA (US); Carlos Chue, San Diego, CA (US); Anthony Tang, San Diego, CA (US); Reza Ghanbari, San Diego, CA (US); Dyami Calire, Encinitas, CA (US); Eric VanLydegraf, Solana Beach, CA (US); Meliza P. Sanchez, Carlsbad, CA (US); Trent Barnes, Vista, CA (US)

Correspondence Address: Glenn E. Von Tersch, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/940,332

(22) Filed: Aug. 27, 2001

Related U.S. Application Data
(60) Provisional application No. 60/228,257, filed on Aug. 25, 2000.
(60) Provisional application No. 60/278,509, filed on Mar. 23, 2001.
(60) Provisional application No. 60/267,851, filed on Feb. 8, 2001.

(51) Int. Cl. G06F 17/50

(52) U.S. Cl. 345/969

(57) ABSTRACT

In one embodiment, a method is described. The method of designing a web application includes designing a set of components, each component having a set of instances. The method also includes designing an application having references to the set of components. The method further includes designing an interface having references to the application, and building the application based on the interface and the designing of the application.

In an alternate embodiment, a method is also described. The method of providing a web-based application includes receiving a request for a web-based application. The method further includes accessing the web-based application. The method also includes accessing a set of objects related to the web-based application within a repository, and executing the web-based application including the set of objects in a manner including interaction with a requestor originating the request for the web-based application.

### BACKGROUND OF THE INVENTION

1. Field of the Invention

The invention generally relates to modular creation of software and more specifically relates to web-based application software.

2. Description of the Related Art

Previously, applications have been developed in a one-size-fits-all approach, allowing for some customization of the applications by the customer. With web sites, typically a set of static pages or perhaps active server pages were provided, each allowing for interesting individual pages, sometimes with a unified theme. However, modifications required modifying actual pages and HTML, requiring a fairly high level of skill to produce a modified product. If customers modify the pages, this can result in confusing or poorly maintained applications. If providers modify the pages, this can result in great expense for the client.

What would be desirable would be a system allowing flexible applications which may be customized at run-time based on such aspects of the execution environment as where the application is being accessed from or who the user of the application is. Furthermore, what is desired is an application which need not be modified at the page level. Moreover, what is desirable is a web-based application which may take advantage of more than a set of pages which are customized once.

### SUMMARY OF THE INVENTION

In one embodiment, a method is described. The method of designing a web application includes designing a set of components, each component having a set of instances. The method also includes designing an application having references to the set of components. The method further includes designing an interface having references to the application, and building the application based on the interface and the designing of the application.

In an alternate embodiment, a method is also described. The method of providing a web-based application includes receiving a request for a web-based application. The method further includes accessing the web-based application. The method also includes accessing a set of objects related to the web-based application within a repository, and executing the web-based application including the set of objects in a manner including interaction with a requestor originating the request for the web-based application.

### BRIEF DESCRIPTION OF THE DRAWINGS

The present invention is illustrated by way of example and not limitation in the accompanying figures.

FIG. 1-1 illustrates an embodiment of a system.

FIG. 1-2 illustrates an embodiment of a process.

FIG. 2-1 illustrates an embodiment of a state machine.

FIG. 2-2A illustrates an alternate embodiment of a state machine.

FIG. 2-2B illustrates another alternate embodiment of a state machine.

FIG. 2-3 illustrates yet another alternate embodiment of a state machine.

FIG. 2-4 illustrates an embodiment of a medium.

FIG. 2-5 illustrates an embodiment of a method.

FIG. 2-6 illustrates an embodiment of a set of state machines.

FIG. 2-7A illustrates an embodiment of a displayed page including a component.

FIG. 2-7B illustrates an embodiment of a displayed page including a component after a state change in the component.

FIG. 2-8A illustrates an embodiment of a method of handling a state change.

FIG. 2-8B illustrates an alternate embodiment of a method of handling a state change.

FIG. 2-8C illustrates another alternate embodiment of a method of handling a state change.

FIG. 2-8D illustrates yet another alternate embodiment of a method of handling a state change.

FIG. 3-1 illustrates an embodiment of a prior art security system.

FIG. 3-2 illustrates an embodiment of a security system.

FIG. 3-3 illustrates an embodiment of a method.

FIG. 3-4 illustrates an alternate embodiment of a security system.

FIG. 3-5A illustrates an embodiment of a state machine.

FIG. 3-5B illustrates an alternate embodiment of a state machine.

FIG. 3-6A illustrates an embodiment of a web page.

FIG. 3-6B illustrates an alternate embodiment of a web page.

FIG. 3-7 illustrates an embodiment of a method.

FIG. 4-1A illustrates an embodiment of a system.

FIG. 4-1B illustrates an alternate embodiment of a system.

FIG. 4-2 illustrates an embodiment of a process.

FIG. 4-3 illustrates an alternate embodiment of a system.

FIG. 4-4 illustrates an alternate embodiment of a process.

FIG. 4-5 illustrates an embodiment of a medium.

FIG. 4-6 illustrates an embodiment of a system.

FIG. 4-7 illustrates an embodiment of a process.

FIG. 4-8 illustrates an alternate embodiment of a medium.

FIG. 5-1 illustrates an embodiment of a system.

FIG. 5-2 illustrates an embodiment of a repository.

FIG. 5-3 illustrates an embodiment of a process.

### DETAILED DESCRIPTION

A method and apparatus for implementing a web application is described. In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

In one embodiment, a output composition processor works in conjunction with a state engine, a services manager and security to utilize information in a repository to provide an application for use by a user. The output composition processor responds to requests from a client to provide information or applications to the client. The output composition processor uses the services manager to access information in the repository. The output composition processor then builds that information into a customized application based on information provided in the request. The output composition processor uses the state engine to run state machines which make up the application or components thereof, and uses security within the application to control access to data.

In an alternate embodiment, an application and components are designed separately, with the application utilizing the components. Additionally, the interface between the application and users of the application is designed separately. The application is then built utilizing the interface, application and component designs. The application is then customized according to needs of a specific user or customer. The application is then used by the user or customer.

Note that components as described in this application refer to fairly highly evolved and complex objects having embedded therein a user interface, state information, data, security and personalization information or functionality. As such, components may be thought of as simple applications, suitable for a wide variety of uses within the context of the present document, rather than the traditional simple components used as the basic building blocks of programs. These high-order components may be manipulated (used) in a manner allowing for selection, customization and use by users well beyond those having advanced technical knowledge. In one embodiment, these components are XML files suitable for implementing a mini-application or simple application, though the root component may have within it portions which may be substituted based on the environment in which the component will be used at run-time.

Through the use of design tools and methodology, users who will actually use the end product (application for example) or those of similar skill can utilize these components to create the end product. UDDI (Universal Description, Discovery and Integration), for example, can be used in conjunction with WSDL (Web Services Description Language) and SOAP (Simple Object Access Protocol) to allow a user to access components and integrate these components into a viable web-based application. The descriptions associated with the components may be counted on to provide enough information for the user to intelligently utilize the components, while the tools used to implement applications may be counted on to handle the low-level details of integrating components into an application in a proper manner. As such, a user such as an end-user may assemble a useful program without requiring the services of a specialized IT group.

Note that in some embodiments, the component may be subdivided or broken down into artifacts, such as the state machine, security, personalization, or other portions of the component which various tools may then manipulate. In such embodiments, the tools inherently have the capability to manipulate the components in this manner based on standard design methodologies and interfaces between the components and the tools. Thus, a high degree of customization or specialization of components and thus applications may be achieved without a need for a corresponding high level of sophistication on the part of the user manipulating the components to form an application.

Implementing these components and utilizing these components depends on several aspects. One aspect is use of a state machine and state engine to handle most of the logic internal to the component, thereby allowing for control of an application based on a state machine described in XML for example. Another aspect is provision of security, either through a token-based approach or through use of levels of security and permission-based models for example. Yet another aspect is an output composition manager which works in conjunction with the state machine to determine the output of the component or application into a useful format such as an HTML web-page or some machine-readable format useful in device-to-device connections. Still another aspect is management of the link between a repository of component instances which may be utilized to customize the application based on various attributes of the environment in which the application will be used.

### State Machine

A state machine may be provided to manage execution and display of a web site. The state machine may oversee execution of display states and action states and may also maintain an environment in which the states may be executed. The code or objects used to implement each state may then interact with the state machine and the environment. Thus, the code or objects may be simpler and may be reused to implement a variety of web sites. Moreover, a history of a user's interaction with a web site may be maintained.

Providing a state machine to manage execution and display of a web site may help to eliminate errors. It may be used to effectively control reused code, ensuring that the various portions of code or objects interact properly even though they are used in different configurations. It may also be used to track execution and interaction with users, thus avoiding errors resulting from unpredictable user behavior or transmission difficulties.

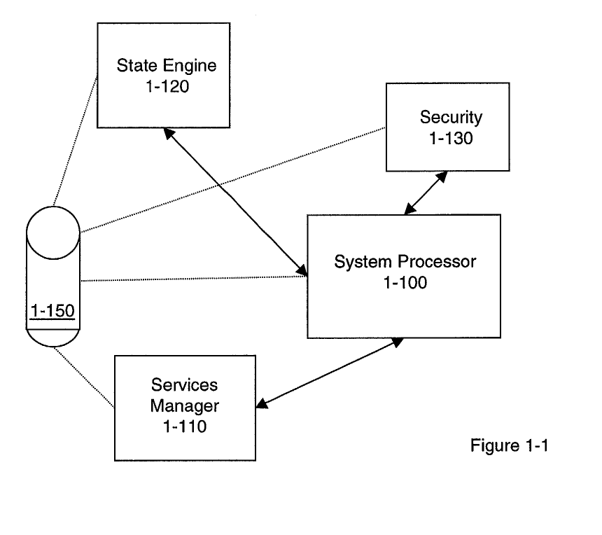

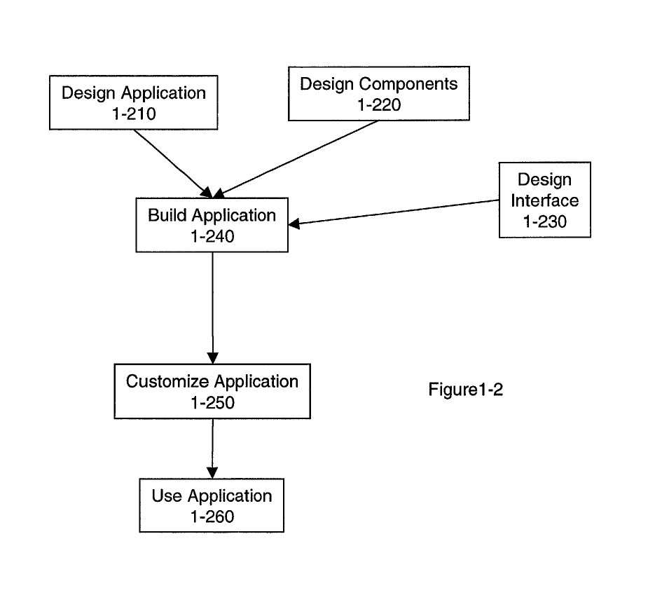

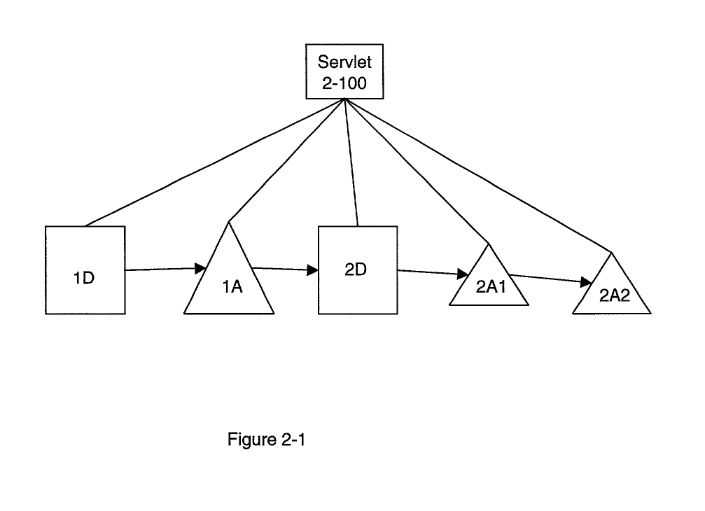

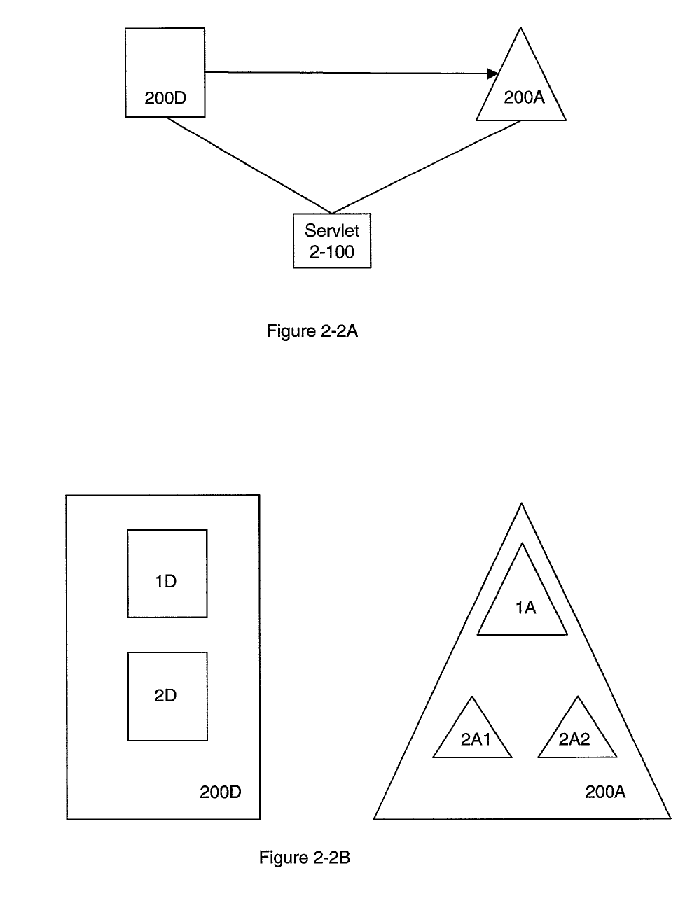

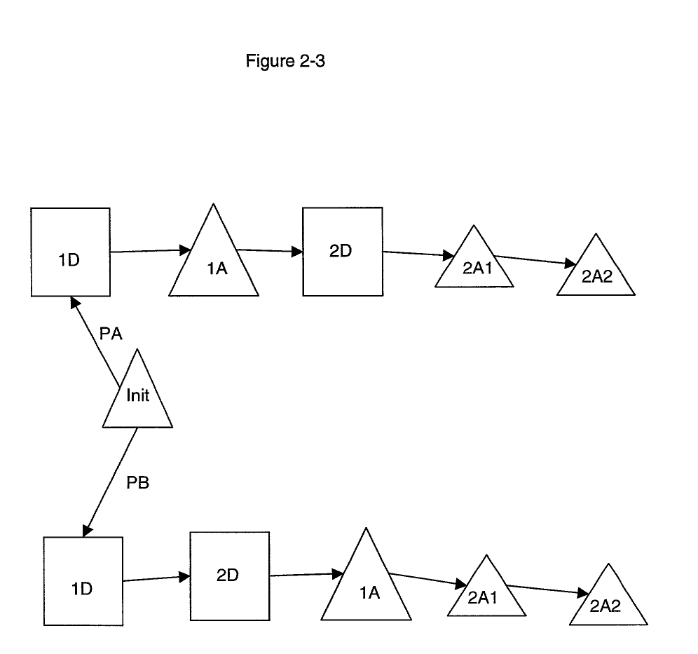

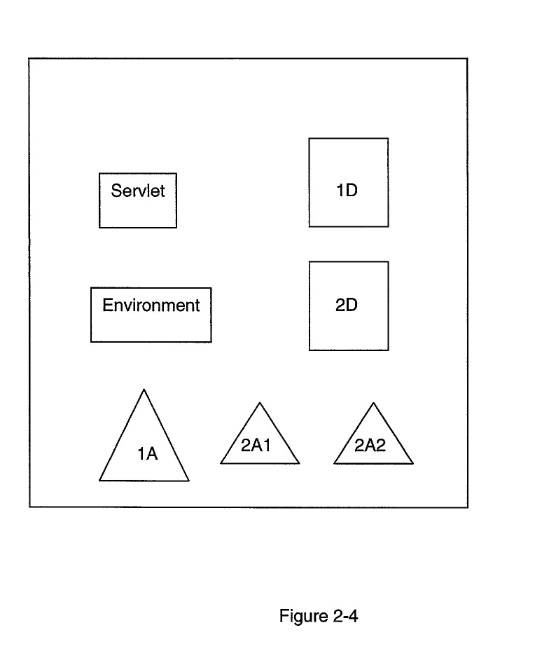

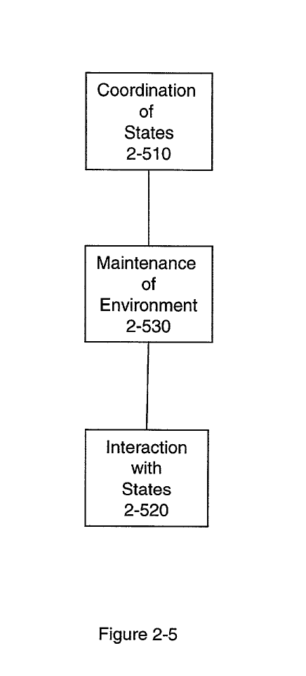

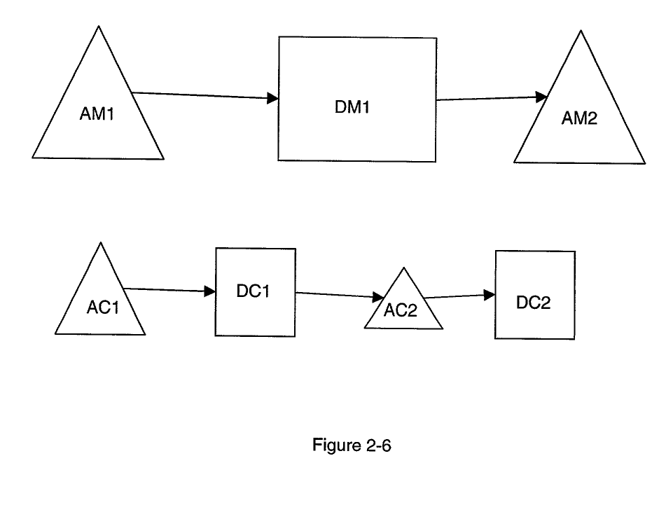

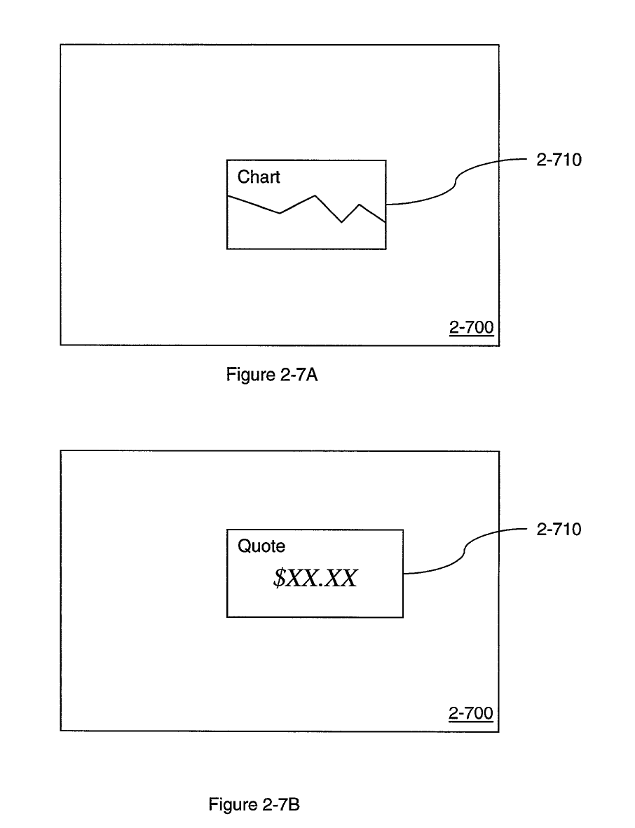

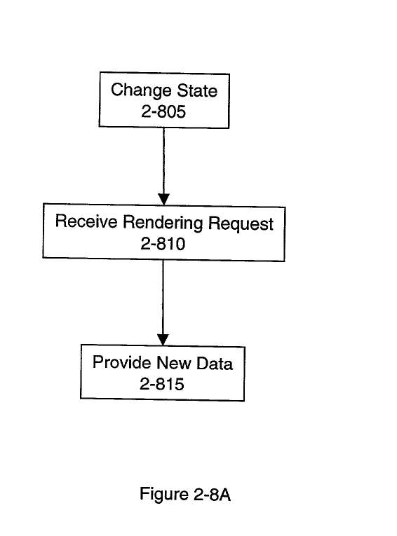

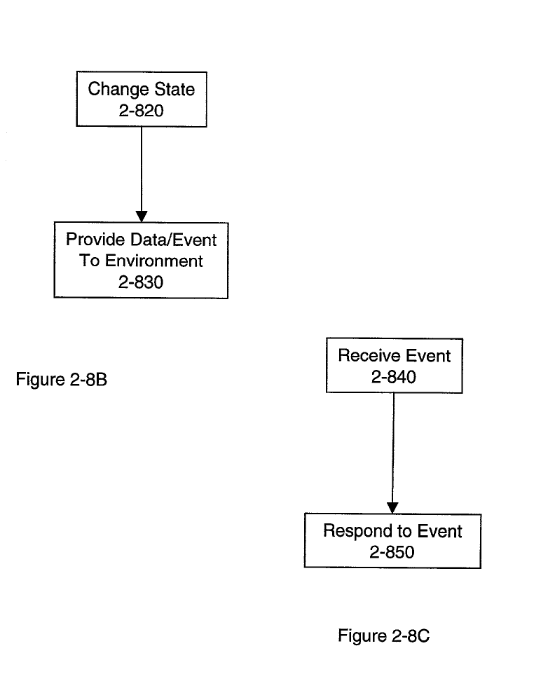

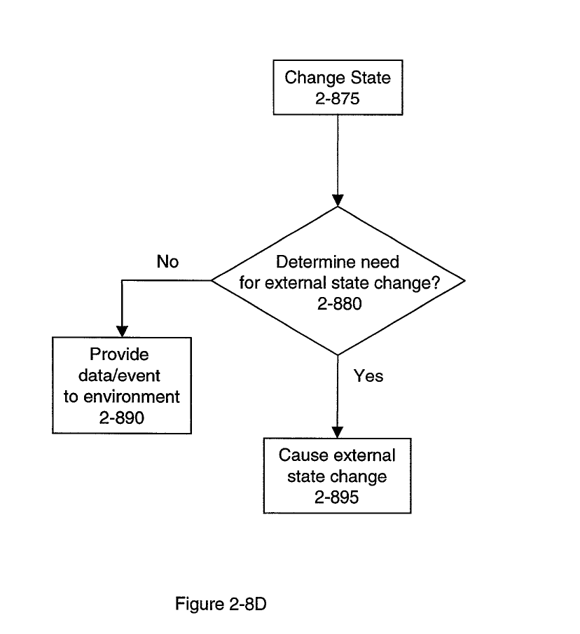

FIG. 2-1 illustrates an embodiment of a state machine and corresponding states. Servlet 2-100 implements the state machine, and may be an object or a procedure or other set of code suitable for execution by a processor. In one embodiment, servlet 2-100 accesses a table of states which contains information about what code or objects implement each state and what the next state should be after each state is executed. Thus, servlet 2-100 may access the table of states and then cause execution of the appropriate code or activity by the appropriate object to occur.

State 1D is a display state. Display states involve display of a web page, and may be implemented as HTML code in one embodiment. A display state may result in an action taken by a user. State 1A is an action state. Action states involve some form of internal action or execution by the machine used to execute the web site in one embodiment. Similarly, state 2D is a display state, and states 2A1 and 2A2 are action states.

In one embodiment, state 1D displays a login screen to which a user submits a user identification (userid) and a password. The servlet 2-100 maintains the userid and the password in the environment, and passes execution on to state 1A. In state 1A, the userid and password are validated, a determination is made as to whether they are valid and as to whether they match each other. The servlet 2-100 then passes exection to state 2D, a list of products is displayed and an order may be accepted.

Next, the servlet 2-100 passes execution to state 2A1, order information as submitted by a user in state 2D is extracted from the environment and a determination is made as to whether the order may be filled. This determination may include actions such as checking for availability of a product, whether the user is permitted to order the product, and any other details that may be appropriate. Then the servlet 2-100 passes execution to state 2A2, the order is generated, with appropriate shipping information from the user (such as information in a stored profile) along with the actual order information such as product identification, quantity, price, and other relevant information.

FIG. 2-2A illustrates an alternate embodiment of a state machine and corresponding states. In this embodiment, servlet 2-100 accesses a table which contains only two states, state 200D (a display state) and state 200A, an action state. FIG. 2-2B illustrates components of the states illustrated in FIG. 2-2A. As will be apparent, both the display portions of state 1D and state 2D are incorporated into state 200D. Similarly, the action portions of states 1A, 2A1 and 2A2 are incorporated into state 200A.

Thus, in one embodiment, both the login information and product order information are displayed as part of state 200D, and both login information and order information may be accepted in state 200D. Then, the servlet 2-100 passes execution to state 200A, where the login validation, order availability determination, and order generation occur. It will be appreciated that the actions may occur in serial or parallel fashion, provided that the order generation does not complete successfully unless both the order availability determination and login validation complete successfully. Furthermore, it will be appreciated that the states of FIGS. 2-1 and 2-2 may only represent a subset of the necessary states for implementing a full web site of linked web pages.

One may refer to a set of associated states as a wizard, and the wizard may be expected to be suitable for accomplishing some task associated with the web site. Thus, states 2D, 2A1 and 2A2 of FIG. 2-1 may be a wizard which in one embodiment may be used to receive and generate an order. Similarly, one may refer to a set of wizards as an application, and a complete domain (including a set of applications) may be suitable for implementation of an entire web site or a portion of a web site. In some embodiments, each wizard may have a separate state table, while an application has a state table with references to each wizard and a domain may have a state table with references to each application. Alternatively, a domain may have a single state table with references to each state in the domain, and with wizards and applications defined as portions of the domain.

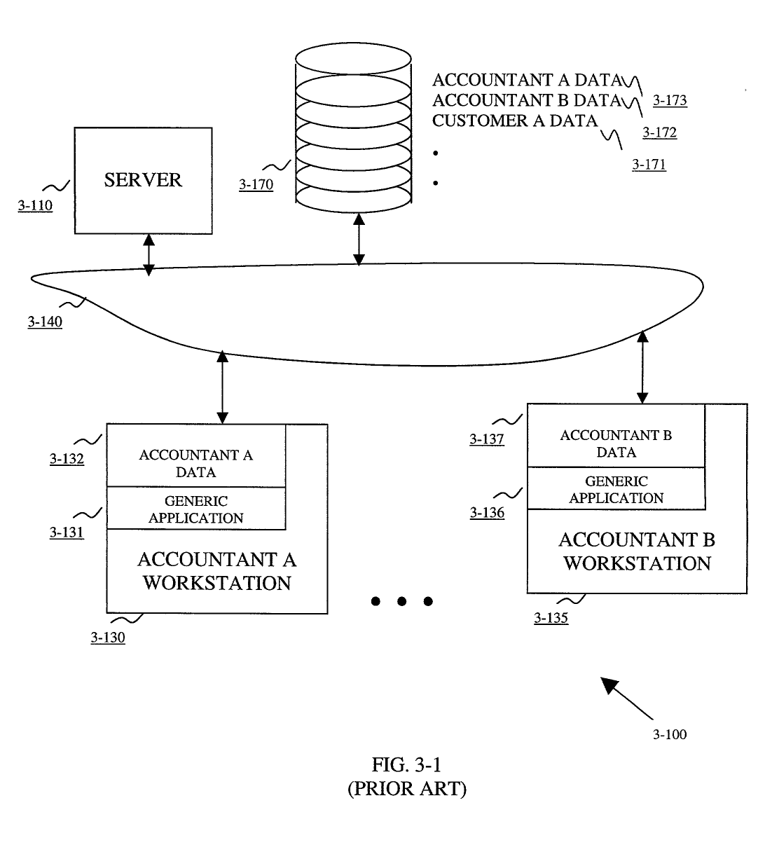

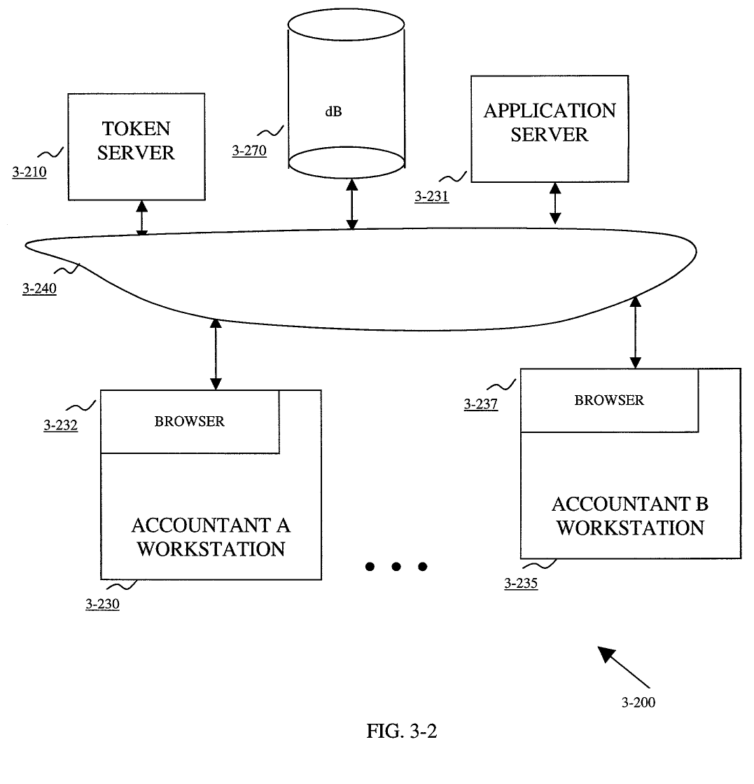

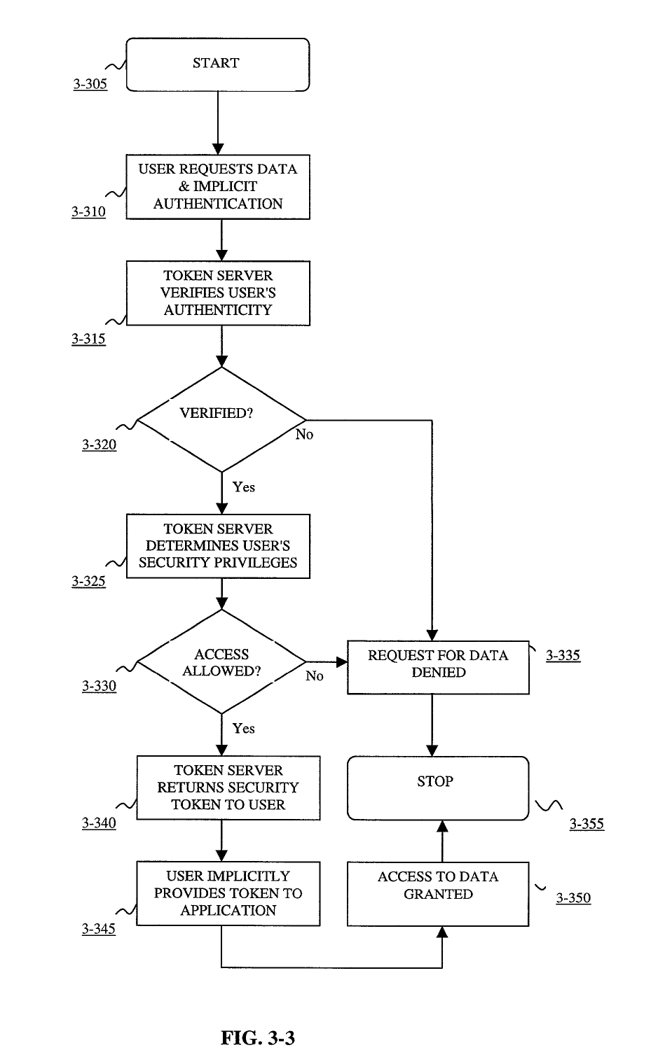

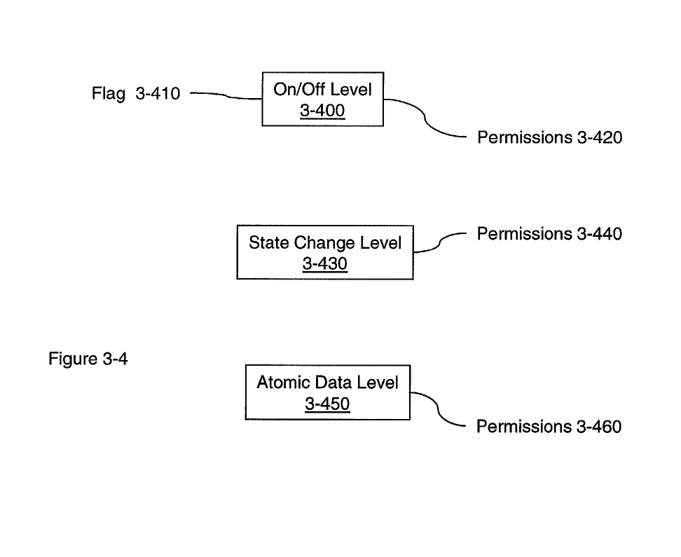

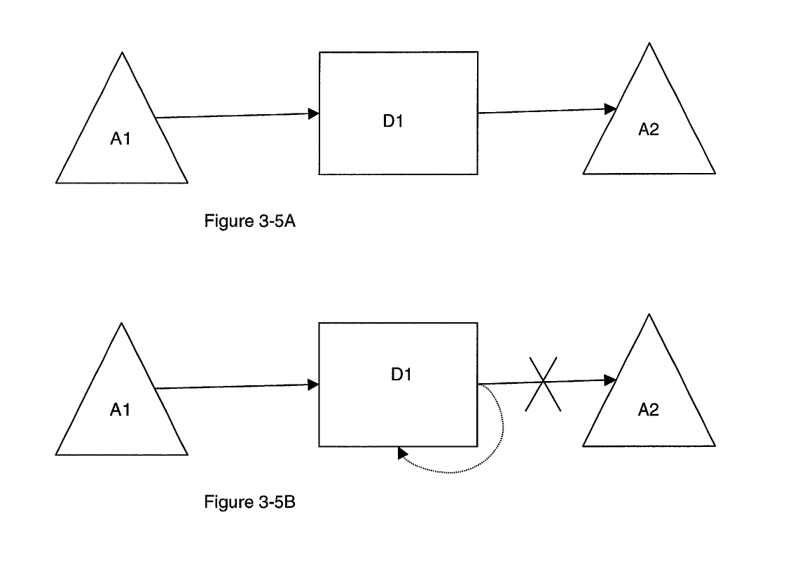

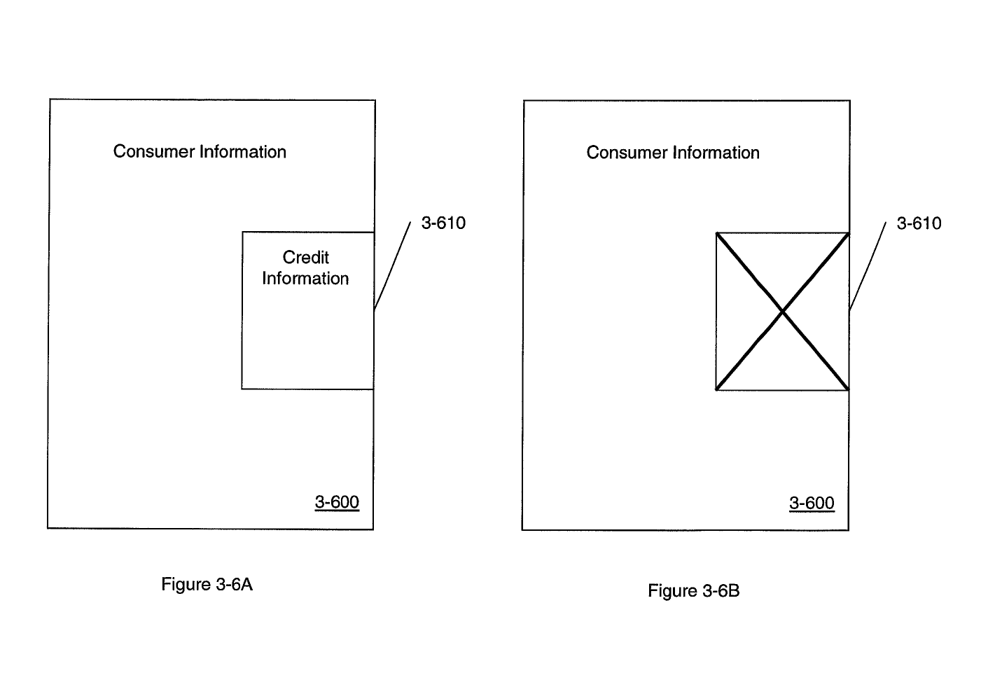

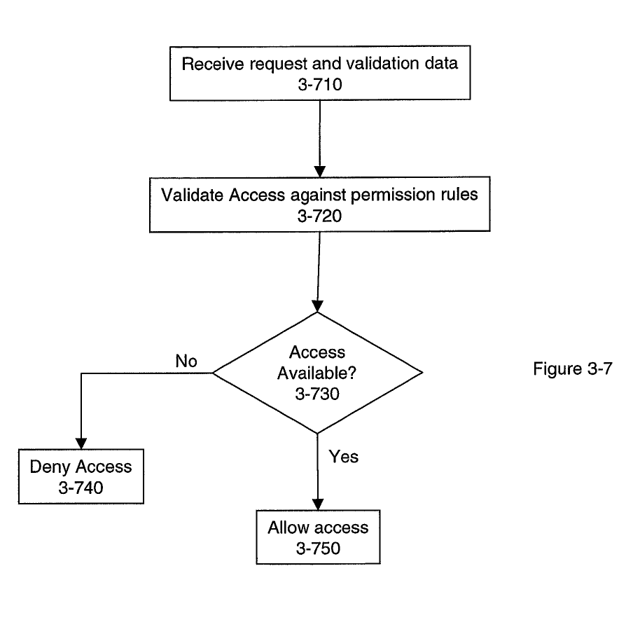

FIG. 2-3 illustrates another alternate embodiment of a state machine and corresponding states. In this embodiment, the init state makes a determination of whether path PA or path PB is suitable for execution. This determination may, for example, be based on how the web site is being accessed (fast or slow connection for example) or on where (what URL) the user was at prior to accessing the web site. Should path PA be chosen, the states will be executed in a first order. Should path PB be chosen, the states will be executed in a second order. It will be appreciated that the states following paths PA and PB need not be identical, and that the linkages may be arbitrarily complex. However, it will be similarly appreciated that the servlet may be expected to control execution of the states regardless of which path is chosen.

FIG. 2-4 illustrates a medium embodying instructions and data suitable for use as a state machine and corresponding states. It will be appreciated that the information stored in the medium may vary depending on what is suitable for the particular medium. For example, the environment data may not be suitable for storage in read-only memory or other media which is not suitable for the rapid changes that may be expected in the environment data. Similarly, random access memory used by a processor to store the instructions may only store some portion of the instructions at any one time. All the same, the components used to execute a web site may be stored in the media separately or together. A processor may then access these components as necessary to execute the web site.

FIG. 2-5 illustrates one embodiment of a process of executing a state machine. At block 2-510, the states are coordinated, such that execution of the applicable code or action by the applicable objects occurs in a proper manner for each state and the transition from one state to the next occurs properly. At block 2-520, the environment is maintained. This includes creating, managing and deleting instances of objects or other data and in particular may include managing any data which the various states may need access to. At block 2-530, the states interact with the state machine and the environment. This may include passing messages from state objects to environment objects, modifying environment data, or communicating a success or failure result from a state to the state machine. It will be appreciated that the blocks of FIG. 2-5 represent portions of a process or method which may occur either in parallel or in serial fashion in a multitasked or single-task environment. Furthermore, it will be appreciated that implementation of these portions of the process may occur in a variety of ways within the spirit and scope of the invention. In particular, the state machine and state code may be written in C, may be implemented as C++ objects, or may be implemented as XML code, thus resulting in different communication methodologies and execution patterns without departing from the spirit of the invention.

As will be appreciated, an alternate embodiment of a state machine may be utilized. In one embodiment, an application and components utilized by the application may have separate and independent states. As illustrated in FIG. 2-6, two independent state machines may exist, with a first state machine having a subset of states illustrated as states AM1 (an action state), DM1 (a display state) and AM2 (another action state). The second state machine illustrated has a set of states AC1, DC1, AC2 and DC2, where AC1 and AC2 are action states and where DC1 and DC2 are display states. As will be appreciated, in one embodiment, the first state machine corresponds to an application, while the second state machine corresponds to a component used by the application.

As illustrated in FIG. 2-7A, a page 2-700 is displayed, including a component display 2-710. In one embodiment, the component is used to display information about a stock trading on a stock exchange, and that information is displayed as a chart in FIG. 2-7A. Turning to FIG. 2-7B, a change in state in the underlying component, combined with a request to compose or display the page again, results in display of the stock information as a quote in component display 2-710, such as a quote for the most recent trade of a stock. In the example illustrated, the rest of page 2-700 is unchanged, only the component changed. This can be achieved by allowing for independent state machines for the components used to generate portions of a page.

For example, in one embodiment, a page at state DM1 of the first state machine displays a component having states corresponding to the second state machine. The component, at state AC1, gathers information suitable for making a chart related to a stock. At state DC1, the component causes that information to be displayed as a chart. A signal to the component causes the component to transition to state AC2, wherein the component gathers information suitable for display as a stock quote, and at state DC2, the component displays the information in quote form.

The process undergone by the component or by any state machine may be illustrated with respect to FIG. 2-8A in one embodiment. At block 2-805, a state change occurs. This may represent a single state transition, such as a transition from one display state to another, or multiple state transitions. At block 2-810, a composition request is received by the object incorporating the state machine. In response, at block 2-815, the object provides data suitable for allowing composition of the display corresponding to the object in its current state. An external system may then use the data provided to properly compose the display, such as transmitting that data in HTML form to a client for use by the client in displaying a page. If the object is a component which only affects a portion of a page, for example, then the data to be composed may be only a small portion of the overall data on the page, allowing for faster transitions in display of pages or portions of pages.

Note that individual state machines may relate to their environment in different ways. For example, as illustrated in FIGS. 2-8B and 2-8C, two state machines may have strong control over their individual environments, using events to communicate. At block 2-820, a component state machine changes state. At block 2-830, the component state machine provides data or an event to the environment, such as an event which triggers a change in the state of another state machine or causes a jump to another page. At block 2-840, a master or external state machine receives the event or data. At block 2-850, the external state machine handles the event and responds appropriately. In situations where the event requires redisplay of a page, the page is redisplayed. In situations where the event causes a state transition, the state transition occurs. It will be appreciated that some events or data may cause errors or exceptions, too. Also, in such an embodiment, it will be appreciated that the external state machine maintains control, and this implies that the component state machine cannot trigger a change in a page or a state machine that could not have occurred as part of the structure of the external state machine.

With respect to another embodiment, FIG. 2-8D provides an illustration. In some embodiments, a state machine may have some level of control over its external environment. At block 2-875, the state machine changes state. At block 2-880, a determination is made as to whether an external state machine also needs to change state. If so, at block 2-895, the state change in the external state machine is triggered. If not, data or an event is provided to the environment at block 2-890. It will be appreciated that one state machine surrendering control to another state machine like this will be an unusual situation as it will tend to make programs less instead of more modular.

### Security

A method and system for restricting access to data on a computer network is disclosed. In one embodiment, sensitive data is requested from a datastore via a generic application. The system authenticates the identity of the user requesting the sensitive data. The security privileges of the user are determined. A security token is generated if the user is authenticated and has security privileges for the sensitive data. The system provides the security token to the generic application requiring the security token. In the following detailed description, numerous specific details need not be used to practice the present invention. In other instances, well known structures, interfaces, and processes have not been shown in detail in order not to unnecessarily obscure the present invention.

FIG. 3-2 shows a high-level block diagram of a system for restricting access to data on a computer network. Note that any or all of the components of the system illustrated in FIG. 3-2 and associated hardware may be used in various embodiments of the present invention; however, it will be appreciated by those of ordinary skill in the art that any configuration of the system may be used for various purposes according to the particular implementation. The system of FIG. 3-2 includes workstations 3-230 and 3-235. A user may access system 3-200 via workstations 3-230 and 3-235 that are equipped with network browsers 3-232 and 3-237 respectively. Browsers 3-232 and 3-237 may be a generic browser such as Netscape's Navigator,™ or Microsoft's Internet Explorer.™ Browsers 3-232 and 3-237 support a login prompt that requires a user to enter an user identification and password. For example, the user of workstation 3-230 may be Accountant A and the user of workstation 3-235 may be Accountant B, both with individual passwords. In one embodiment of the present invention, the workstations 3-230 and 3-235 are IBM® compatible personal computers (PC), Apple Macintosh® personal computers, or SUN® SPARC Workstations. The software implementing the present invention can be stored on any storage medium accessible by workstations 3-230 and 3-235, or application server 3-231.

The system 3-200 further includes an application server 3-231. Application server 3-231 may execute a generic program that can be accessed by workstations 3-230 and 3-235. For example, the generic program may be an accounting ledger program that manages accounting line items for both the accounts of Accountant A and the accounts of Account B, as well as any other registered users having access to system 3-200. Sensitive data, such as accounting line items are stored in datastore 3-270.

System 3-200 restricts Accountant B's access to the sensitive data contained in the accounts of Accountant A. This is accomplished by implementing a token server 3-210 to interact with the other components of system 3-200. When a user request access to sensitive data, the generic application server 3-231 will check to see if the user possesses a valid token created by token server 3-210. If the user has a valid security token, then the user will gain access to the sensitive data stored in datastore 3-270. Otherwise, the user will be denied access to the sensitive data. So, if Accountant A attempts to acquire a security token for the ledger of Accountant B, the token server will not issue a security token to Accountant A. Thus, Accountant A is unable to successfully request the Ledger Service to delete ledger line items of Accountant B. As the security token is the parameter used for the delete ledger or line item function, the security token encapsulates parameter level security. The Ledger Service does not need to write specific security code to protect the parameters encapsulated within the security token. Thus, even though Accountant A may have permission to delete her own line items, Accountant A still needs a valid token to access specific line items, such as the line items of Accountant B.

For each token it creates, the token server 3-210 keeps track of which user is given each token. When a token is submitted to the token server 3-210 for authentication, the identity of the submitting user must match the user identification associated with the token as stored on the token server 3-210. The password associated with a user identification is also stored on the token server 3-210. Private keys and certificates, such as X.509, may also be stored on token server 3-210.

The tokens created by token server 3-210, also include an ability to self check for tampering. If the token detects that any data stored in the token has been tampered with, the token becomes invalid. Thus, if information is attempted to be added after the creation of the token, the electronic validating signature stored on the token fails. An electronic signature is only valid for the information contained in the token at the time when the signature was created. Furthermore, tokens may be programmed to expire after a certain amount of time, such as a number of days, a certain amount of inactivity, or certain number of uses.

All components of system 3-200 are interconnected by network 3-240. Network 3-240 may be any large area network, (LAN) wide area (WAN) network, or local network including the Internet. In general, the network architecture of the present invention can be implemented as a standard telephone connection provided through an Internet service provider to enable data communication on the Internet over a conventional telephone network. This use of the Internet as a distribution network is well known to those of ordinary skill in the art. In an alternate embodiment having cable modem capability, communication over a conventional cable network is possible in lieu of communication over the telephone network. The cable network is typically much faster (i.e. provides a much greater bandwidth) than the standard telephone network; however, cable modems are typically more expensive than standard POTS (plain old telephone system) modems. In another alternate embodiment having conventional Integrated Services Digital Network (ISDN) capability, the network 3-240 is accessed using an ISDN modem. Again, the ISDN network is typically faster than the POTS network; however, access to an ISDN network is generally more expensive. Cable modems and ISDN implementations are alternative communications media to the POTS implementation.

The system 3-200 prevents theft of security tokens, because a stolen token is useless unless the thief knows the user identification and password that is associated with the token. Furthermore, security tokens may only be created by token server 3-210. In one embodiment, the tokens are created using any public key/private key technologies, such as that built into standard JAVA security models. Any application, such as those that are run on application server 3-231 may verify that the tokens were created by the token server 3-210. Thus, system wide security changes are fully adaptable during back-end design of the generic application. In addition the token stores the identity of the user requesting access to the sensitive data secured by the token.

In another embodiment, system 3-200 is fully compatible with existing JAVA 2 security schemes and adds an additional layer of security through the use of tokens. Thus, system 3-200 may use a standard JAVA object, but add to it a security signature. The security signature may not be forged because only token server 3-210 can write the security signature to the object. System 3-200 can verify whether the object has been tampered with, or if the object has been provided to the wrong user by verifying if the object was created with token server 3-210.

System 3-200 eliminates the need to develop separate hacker detection systems, because tokens insure the authenticity of the user. Developers of generic applications run on application server 3-231 can set the level of security desired. The developer may decide what sensitive data may or may not be exposed. The tokens may be as “fine grained” as the developer requires. For example, token protection may be implemented with every piece of data contained in an accounting ledger, or tokens may protect data at departmental levels, where all managers have full access, whereas accountants only have access to add line items. User access to the data and applications of system 3-200 is not direct, but access is only allowed after receiving an authenticated token from the user and verifying that the necessary privileges are embedded within the token.

Referring now to FIG. 3-3 which is a flow chart showing the logic implemented by the present system for restricting access to data on a computer network. The process commences in block 3-305. A user initiates the process by requesting data from datastore 3-270. The request may be an implicit request generated while the user is running the application executed on application server 3-231. For example, Accountant A may request to delete a line item from an account of Accountant B. Accountant A has implicitly requested data from datastore 3-270. Similarly, in processing block 3-315, the user's identity is authenticated against the user identification and password stored in token server 3-210.

In decision block 3-320, if the token server 3-210 is unable to verify the user's authenticity then flow passes to processing block 3-335 where the user's request for the data is denied and processing terminates in block 3-355. If the token server 3-210 verifies the user's authenticity, flow continues to processing block 3-325.

In processing block 3-325, the token server 3-210 determines if the user has security privileges to access the sensitive data requested in processing block 3-310. In decision block 3-330, if the token server 3-330 determines that access is allowed, flow continues to processing block 3-340. If access is denied, flow passes to processing block 3-335 where the user's request for the data is denied and processing terminates in block 3-355. If access is granted in decision block 3-330, flow is passed to processing block 3-340 where token server 3-210 creates a new token and returns it to the requesting authenticated user. The user will typically be unaware that the token has been received, since the token will be securely stored within the user's workstation. In processing block 3-350, application server 3-231 will verify that the token is valid and grant the user access to the data requested in processing block 3-310. The process ceases at block 3-355.

As will be appreciated, other methods of implementing security may be utilized. In one embodiment, security is achieved through three levels of potential security. The first level includes a set of permissions and a on/off type of flag or switch. The second level includes permissions associated with states in a state diagram and transitions from one state to another. The third level includes permissions associated with specific data of a component. As will be understood, the permissions discussed herein relate to whether material at a given level is accessible. Known methods of validating whether a given user or system has permission to access data or a component may be used, such as receiving user data and checking that data against a data structure containing specific individuals or classes of individuals and permissions associated therewith. In one embodiment, permissions are of a read, modify and delete variety, allowing a user to do one or more of reading, writing, or removing a piece of data or a component. In an alternate embodiment, permissions are of a read, modify and execute variety, allowing a user to do one or more of reading data from, writing data to, or executing (such as methods or states of a component) some portion of a component according to the permission settings.

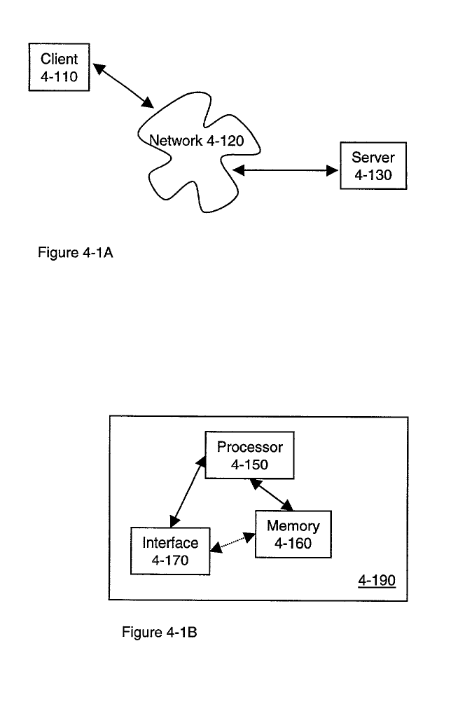

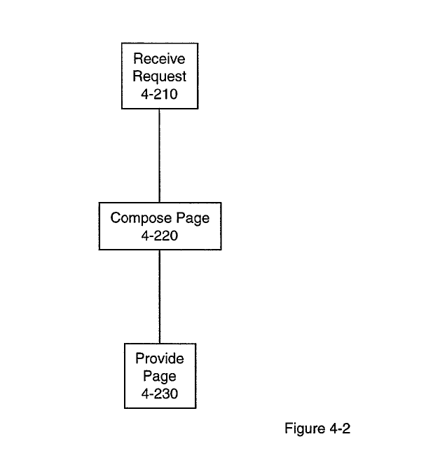

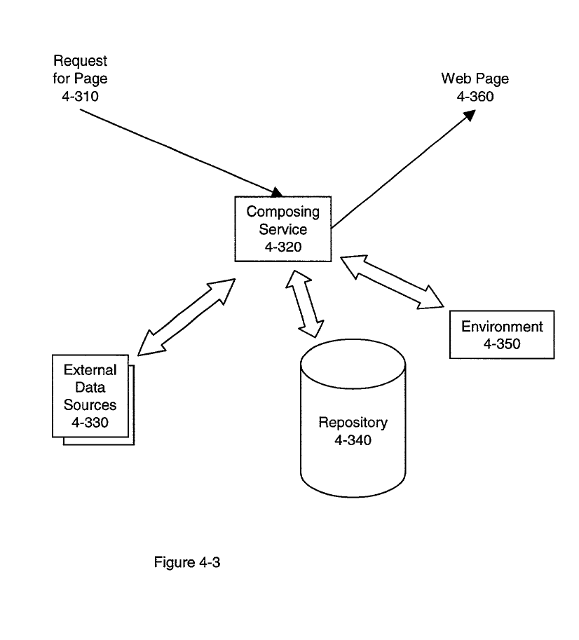

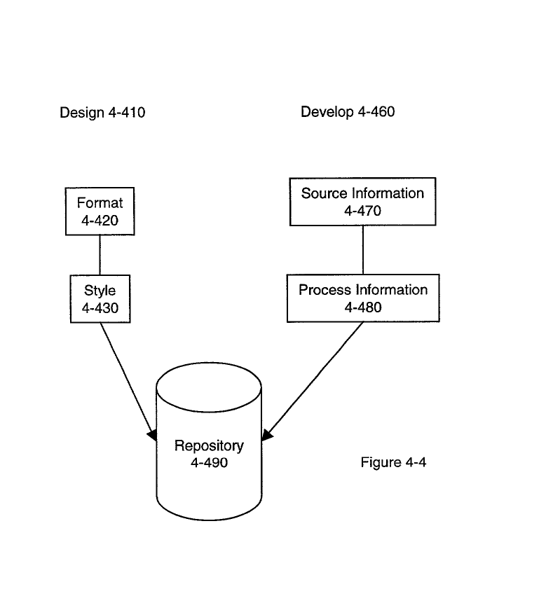

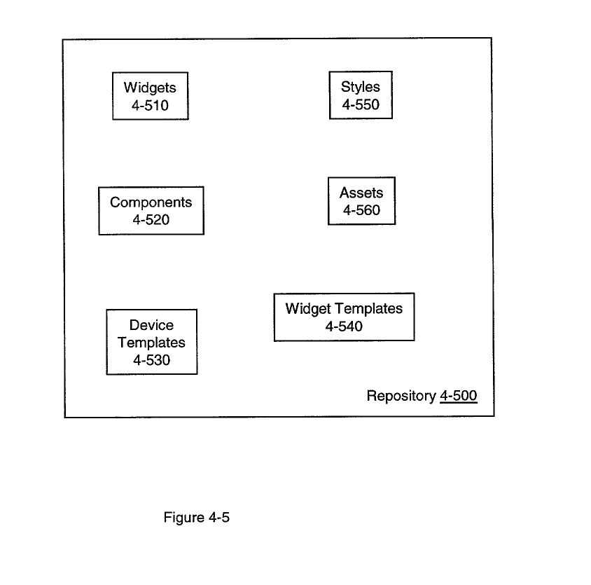

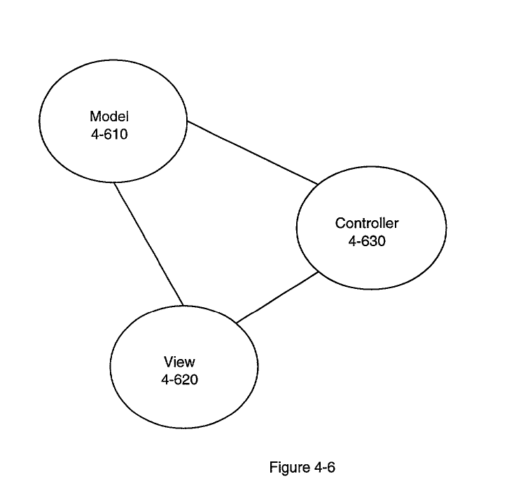

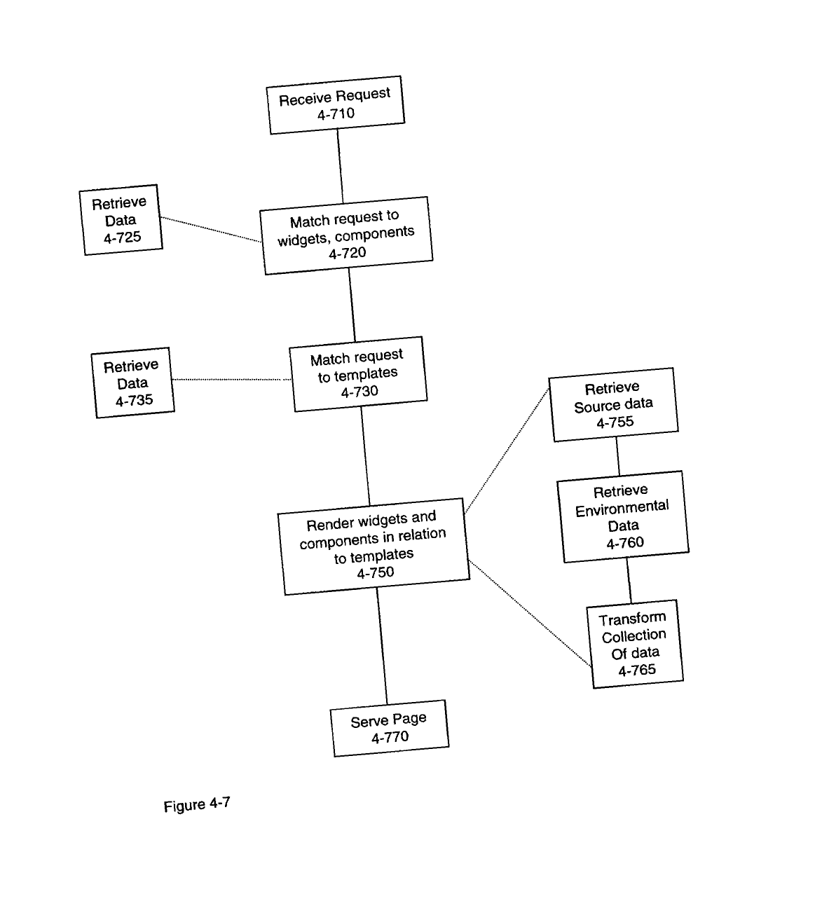

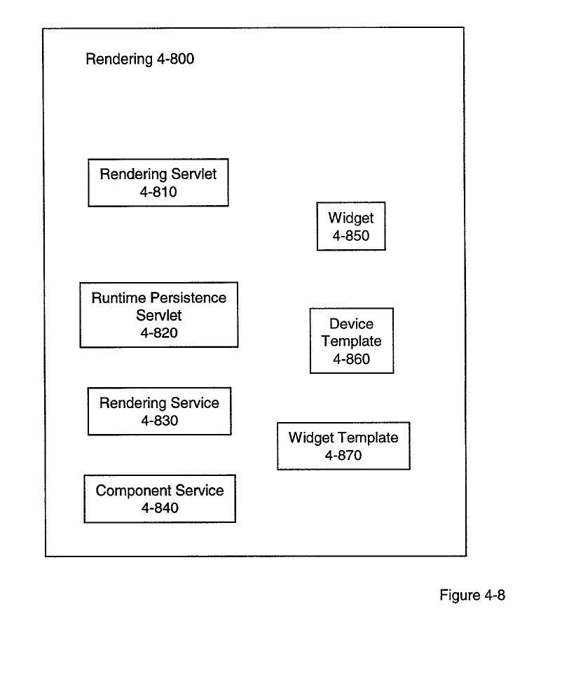

As illustrated in FIG. 3-4, in one embodiment, a hierarchy of security for a component includes three levels. A first level is an on/off level 3-400, which has associated with it a flag 3-410 and a set of permissions 3-420. A second level is a state change level 3-430 which has associated with it a set of permissions 3-440. A third level is an atomic data level 3-450 which has associated with it a set of permissions 3-460.

In one embodiment, the on/off data level 3-400 can be turned on or off by setting a flag 3-410. The flag 3-410 may be set by anyone working with the component in question, such as the component developer, an application developer, or a person customizing a previously developed application. Similarly, access to the permissions 3-420 at this level is available to anyone working with the component, allowing for flexibility in determining what the presence of security means for the component. Thus, a component developer may provide optional security at this level, thereby allowing users of the component to choose whether security should be present or not. Likewise, an application developer may provide security and some level of permissions without relying on the component developer to have implemented security.

At the state change level 3-430, permissions 3-440 are implemented by the developer of the state engine (and corresponding component) and are not subject to change by the application developer under normal circumstances. However, in one embodiment, permissions 3-440 may be set up as a set of classes, with individuals assigned to a class either by the application developer or on a more dynamic basis. As will be appreciated, this requires that the component in question implement methods allowing addition, deletion, or modification of entries in its permission data structure, and expose those methods for external use.

The permissions 3-440 are used to determine whether a state transition is allowable based on the identity of a user or system from which a request originates. Thus, a set of users with high-level access may be allowed use of portions of a state engine which are not allowed to users with low-level access. Moreover, security may be implemented based on whether the request originates from within a trusted system or not for example.

At the atomic data level 3-450, permissions 3-460 are set in a manner similar to permissions at the state change level 3-430. However, at the data level 3-450, permissions determine what access, if any, a user has to specific data. For example, a user with low-level access may be able to see some portions of a customer's data but not all data. A user with mid-level access may be able to see all of a customer's data. A user with high-level access may be able to see and modify a customer's data. This may be implemented by using java beans to embody data for example, and having the java beans include the security access information, thus requiring validation of a user's access prior to providing data to the user, or prior to accepting a modification of data from the user for example.

FIGS. 3-5A and 3-5B illustrate some aspects of how security at the state machine level may be implemented. For example, a state machine may be encoded such that a user with proper security access may achieve a transition from state D1 to state A2. However, a user without proper access may have the transition to state A2 from state D1 blocked as illustrated in FIG. 3-5B. It will be appreciated that a return to state D1 need not be implemented. In fact, the state engine may reroute the user to a state D3 (not shown) in which an error message or similar indication of a failure to transition due to security concerns may be displayed. Furthermore, it will be appreciated that a user may be presented with an opportunity to change security levels or otherwise achieve access to an otherwise forbidden transition based on information that the user may provide at the time the transition is requested.

As illustrated in FIGS. 3-6A and 3-6B, access to information may be blocked even though state machine access is not blocked. For example, in FIG. 3-6A, consumer information in page 3-600 is displayed, including credit information 3-610. Credit information 3-610 may consist of sensitive information (such as consumer credit card numbers for example) which should only be available to certain people in an organization. FIG. 3-6B illustrates a view of page 3-600 in which the credit information 3-610 is blocked because of security concerns. Note that the actual format of the information may take a variety of forms, here the credit information 3-610 is displayed as an X indicating lack of access.

FIG. 3-7 illustrates an embodiment of a process of evaluating secure access. At block 3-710, a request for access is received, along with any validation data which may be suitable. At block 3-720, access is validated against permission rules in place, providing for a determination as to whether access should be available. At block 3-730, the determination of whether access should be available is made, based on the validation performed at block 3-720. If access should not be granted, access is denied at block 3-740. Otherwise, access is granted at block 3-750. As will be appreciated, this process may be applied at each of the three levels described. Also, this assumes some form of login or other process of providing validation data. Thus, provision of validation data may occur on an initial basis or on a continuous basis, depending on the preferences of those implementing the system.

### Output Composition Processor

The method, apparatus or system may be expected to compose pages or other data output utilizing a highly modular and reusable set of components and widgets or similar building blocks and external sources of data. Moreover, by using such building blocks, the method, apparatus or system may provide for ease of development and design of pages or other forms of data. The composed pages may be served over the internet or another suitable network to requesters, and the requesters may be machines or people acting through the use of machines.

FIG. 4-1A illustrates an embodiment of a system. Client 4-110 may be a machine such as a personal computer, a web-enabled phone, a personal digital assistant, a handheld or palmtop computer, or a network-based application, or other device or entity capable of interacting with a network for example. Network 4-120 may be a private, public, or hybrid (public and private) network, such as a wireless or wired LAN or WAN or the Internet for example. Server 4-130 may be a machine capable of interacting with the network 4-120 which has an address to which requests may be sent and has the capability to serve pages or similar forms of data to requesters over the network 4-120. Client 4-110 may be said to be coupled to or coupled directly to network 4-120, and server 4-130 may similarly be said to be coupled to or coupled directly to network 4-120. Additionally, server 4-130 may be said to be coupled to client 4-110 through network 4-120.

FIG. 4-1B illustrates an embodiment of an alternative system 4-190, including a processor 4-150, a memory 4-160 coupled to the processor 4-150, and an interface 4-170 coupled to the processor 4-150. The interface 4-170 may be used to allow access and interaction between the system 4-190 and the outside world, through a network connection, an input or output device such as a keyboard, monitor, or touch-sensitive LCD for example. The memory 4-160 may be used to store data or instructions for execution by the processor 4-150, and may be formed of various media such as those described later in this document. The memory 4-160 may be an integral part of the system 4-190 or a separable component. In one embodiment, both the server 4-130 and the client 4-110 may be embodiments of the system 4-190.

FIG. 4-2 provides a flow diagram illustrating an embodiment of a method. At block 4-210, a request for a page is received. At block 4-220, the page is composed, which may include assembling a representation of the page in memory, accessing portions of the page from external data sources, accessing portions of the page from a repository and executing java or similar code among other things. At block 4-230, the composed page is served to the requestor from which the request of block 4-210 was received.

FIG. 4-3 illustrates relationships in one embodiment of a system and method. The request 4-310 for a page is received by the composition service 4-320. The composition service 4-320 queries a repository 4-340, external data source 4-330 and the environment 4-350 for information related to formulating a response to the request 4-310. The repository 4-340 may provide basic information about the page including styles, widgets and components, all of which may be utilized to build and form a page. The widgets and components may access external data from external data sources 4-330, allowing for display of content which is either up-to-date or otherwise customized either for the content provider or the requestor. The environment 4-350 may provide information such as a requestor's identity, locale information, language preference, potentially even content provider identification information for example.

By utilizing information from the environment 4-350, the composition service 4-320 may make intelligent choices about what content or what options are utilized in composition the page. For example, a page may include a graphic asset which would be an image of a hamburger when the requestor is localized for the United States, and an image of sushi if the requestor is localized for Japan for example. Similarly, currency may be yen or yuan or dollars or francs for example. Moreover, a stock market monitor may monitor the Nikkei, the FTSE, or the NASDAQ for example. With respect to the content provider, a general branding or styling strategy may be employed, allowing a content provider to make all of its pages similar in look-and-feel for example, or making sure that only certain advertisements are included in its pages.

FIG. 4-4 illustrates relationships in one embodiment of a development process or system. Design process 4-410 includes format design 4-420 and style design 4-430, resulting in information in repository 4-490. Development process 4-460 includes Information source searching 4-470 and Information processing coding (development) 4-480, which result in other information in repository 4-490. A designer may thus determine the look-and-feel or aesthetic aspects of a page separately from a developer who may determine how information is retrieved from various sources and how that information is processed into something which may be served as a page. Since all of this results in entries in the repository 4-490, the two processes need not be strongly linked, they may be linked only to the extent necessary to make sure the information processed by the developer's widgets or components will be useful for the designer. Repository 4-490 may be any number of different data storage elements, such as a database which may be queried using SQL, an LDAP or other similar structure, a basic file structure or other information storage mechanism or format.

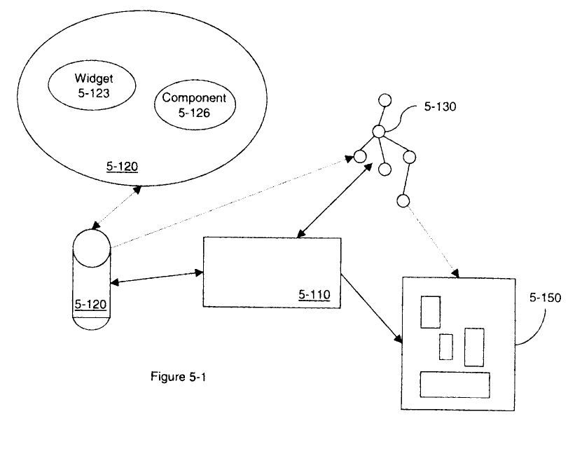

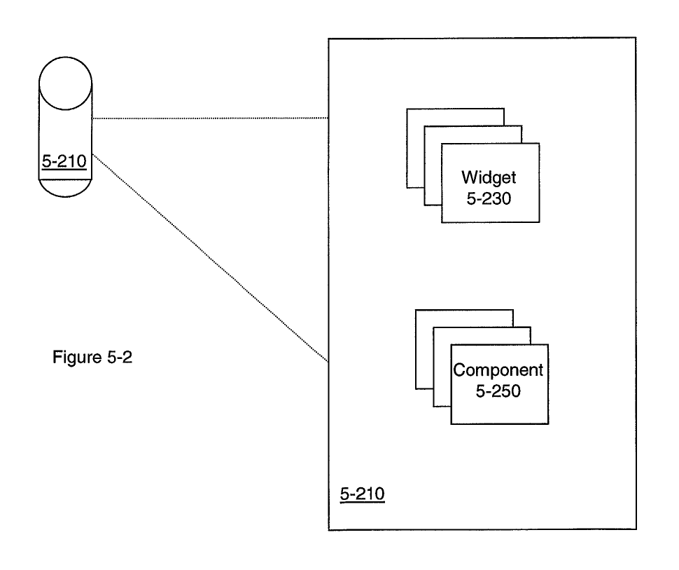

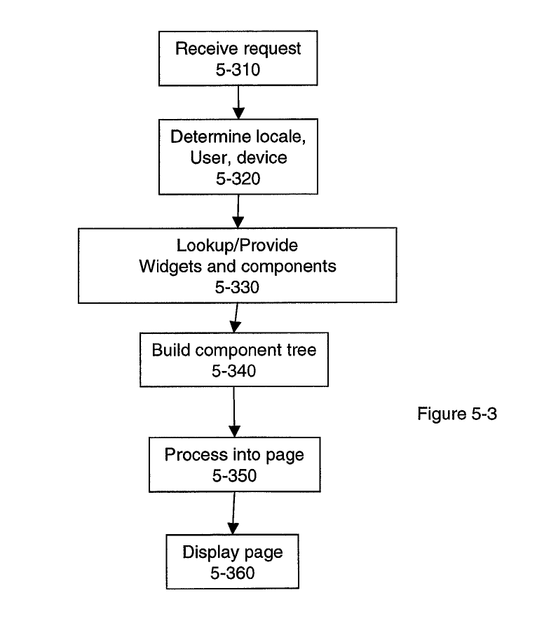

FIG. 4-5 illustrates an embodiment of a repository. In one embodiment, repository 4-500 includes widgets 4-510, components 4-520, pointers to device templates 4-530, pointers to widget templates 4-540, styles 4-550 and pointers to assets 4-560. The widget templates, device templates, and assets may all be accessible by the composition service based on the pointers (to device templates) 4-530, pointers (to widget templates) 4-540 and pointers (to assets) 4-560. In one embodiment, the widget templates, device templates, and assets all reside in files a file system with the repository 4-500, and the separation of the various files from the repository results in a more dynamic and easily maintainable environment. By pre-loading pointers to the various files in the database and predetermining potential variations, better performance is possible when loading the pages.

The widget object 4-510 is an instance of the widget 4-510 and contains all of the data required to compose the widget. At runtime, a widget 4-510 also provides access to all its defined attributes. The device template 4-530 is the main wrapper JSP for a given target device. The composing service forwards to this JSP when it is done building the components for the page. The device template 4-530 includes the main root component of the page by including the widget template 4-540 for the widget 4-510 in the component's current mode, which was previously resolved by a component service when it built the component 4-520.

However, it is sufficient to say that the component 4-520 may be expected to have exactly one widget 4-510 associated with it and thus to be useable by the composing service. Furthermore, the component 4-520 may have various modes which may alter the choice of widget 4-510 associated with the component 4-520. However, it is sufficient to say that the component 4-520 may be expected to have a widget 4-510 associated with it at any given time when the composition service interacts with the component 4-520. Furthermore, the component 4-520, in one embodiment, may be an object which has a method allowing for a query to the component 4-520 to return the widget object 4-510 (an instance of the widget 4-510) associated with it, and the widget object 4-510 thus returned will have attribute data bound to it by the component, thus allowing for access to the component's (4-520) attribute data when composing the widget object 4-510 without directly accessing the component 4-520. Furthermore, the component 4-520, in using the widget object 4-510 to present a view, may get external data or a pointer to an external data source, and bind that external data to the widget object 4-510, thus allowing for access to that external data. In one embodiment, the widget object 4-510 may be thought of as a view of the component 4-520.

This widget template 4-540, in turn, will include any children components 4-520 in the same way (including the widget template 4-540 as described above). The widget template 4-540 (once processed and compiled into a servlet at runtime) translates the widget object 4-510 attribute data that was bound to it into its visual representation. It may also include assets pointed to by pointers to assets 4-560, and applies styling from styles 4-550 if required. Widget templates 4-540 and assets may be chosen based on environment variables such as locale, requestor identity, content provider identity, requestor device capabilities, or other variables for example.

In one embodiment, the taco or sushi pictures described above with respect to FIG. 4-3 would be assets which would be varied based on locale or requester identity for example. In general, assets may be said to be resources which may be utilized in a composed web page which may be varied based on locale, style, or other variables. The pointers to assets 4-560 which are stored in the repository 4-500, in one embodiment, are families of pointers, and the actual pointer used is based on the relevant variables such as locale, identity, or other variables for example. Furthermore, in one embodiment, the widget template 4-540 and device template 4-530 embody the style, format and structure of the web page and individual portions of the web page, thus producing the resulting composed web page. These templates (4-530 and 4-540) may have similar variations to those of assets, in that a given widget may have a different template depending on whether it is used for a web-enabled cell phone or a personal computer or whether it is used in Japan or the United States for example.

In one embodiment, the repository 4-500 includes data and relationships therebetween, and thus may be implemented with a variety of technologies which will be apparent to one skilled in the art. Note that the technology of the underlying contents of the repository 4-500 described with respect to FIG. 4-5 has been described with respect to JSP technology. However, it will be appreciated that the method or apparatus associated with FIG. 4-5 may be implemented with a variety of other technologies, such as ASP (Active Server Page) technology for example. Similar statements will be understood to be true for the various descriptions of this application.

FIG. 4-6 illustrates relationships in one embodiment of a system or method. Model 4-610 is a model for the page requested, and view 4-620 is the view or visual representation of the page. In one embodiment, controller 4-630 matches a request, including aspects of both the request and its environment, to a model 4-610 and a view 4-620 which may be obtained from a repository and which may also depend on external data sources.

FIG. 4-7 provides a flow diagram illustrating an alternate embodiment of a method. At block 4-710, the request for the page is received. At block 4-720, the request is matched with widgets and components and other objects which may make up the model of the page. This may include retrieving data from a repository at block 4-725. At block 4-730, the request is matched to templates and styles and other objects or data which may form the view or visual representation of a page, and this may similarly include retrieval of data from a respository at block 4-735.

At block 4-750, the widgets and components are composed in relation to the templates and styles or formats. This may include retrieval of source data from external sources at block 4-755, retrieval of environmental data at block 4-760 and transformation of collected data including transformation of widgets, components, styles, external data and environmental data for example into a page. At block 4-770, the composed page is served upon the requestor.

FIG. 4-8 illustrates an embodiment of a method or system. Composing a page involves several components. Composing system 4-800 includes composing servlet 4-810, runtime persistence service 4-820, composing service 4-830, component service 4-840, widget 4-850, device template 4-860 and widget template 4-870. The composing servlet 4-810 processes requests to compose pages. It forwards the request to the composing service 4-830 and invokes the appropriate servlet/JSP for the page. The Runtime Persistence service 4-820 encapsulates all operations for the Runtime persistent storage as a service, where the page model is stored. A loader application may be responsible for loading the required data to describe the components, widgets, styles, and pages into persistent storage prior to runtime, allowing for access to the stored data at runtime. The composing service 4-830 is responsible for building the model of a page. It uses the Runtime Persistence service 4-820 to retrieve data from the Runtime datastore (such as a repository). For each component on the page, the composing service 4-830 uses this data to create the corresponding widget 4-850. The page model is returned as a tree structure where the root of the tree is the page widget 4-850.

The component service 4-840 is responsible for actually building the components on the page, performing the required bindings, and setting the appropriate widget 4-850 for the component's mode. The widget object 4-850 contains all the data required to compose the widget 4-850. At runtime, a widget 4-850 also provides access to all its defined attributes. Note that the widget 4-850 and the widget object 4-850 may be two distinct entities which are linked in that the widget object 4-850 is an instance of the widget 4-850. In one embodiment, one would expect to find a widget 4-850 in a repository, and to instantiate a widget object 4-850 based on the widget 4-850. In one embodiment, the composing service 4-830 chooses a widget template based on the environment and other surrounding considerations, while the component chooses the widget based on the component's mode or current state. The device template 4-860 is the main wrapper JSP for a given target device, such as a personal computer or web-enabled phone for example. The composing service 4-830 forwards to this JSP when it is done building the components for the page. The device template 4-860 includes the main root component (widget 4-850) of the page by including the template for the widget 4-850 in the component's current mode, which was previously resolved by the component service when it built the component. This template, in turn, will include any children components in the same way. The widget template 4-870 (once processed and compiled into a servlet) translates the widget 4-850 attribute data that was bound to it into its visual representation. It may also include assets, and applies styling if required.

### Interface to Repository

A method and apparatus for service management may be utilized to provide components or other pieces of an application from a repository. The service management may be expected to work in conjunction with a output composition processor or other software, responding to requests from the processor by providing data as available.

In one embodiment, the services manager works within a system as illustrated in FIG. 5-1. Output composition processor 5-110 requests information from a repository 5-120. The repository 5-120 is illustrated containing widget 5-123 and component 5-126, each of which may represent multiple rather than single objects. In one embodiment, the widgets 5-123 and components 5-126 are to be assembled into an object tree or data structure 5-130 which may be used to implement an application or provide a page for display for example. The page 5-150 may be displayed or transmitted to a client as an HTML page or may be provided in some other form for execution as an application by the client.

In one embodiment, the services manager provides an interface to a repository 5-210 as illustrated in FIG. 5-2. The repository 5-210 includes pointers to components 5-250 and widgets 5-230, and may be viewed as actually including the components 5-250 and widgets 5-230. In one embodiment, the components 5-250 and widgets 5-230 are each individual java code fragments written according to predetermined specifications. Which component 5-250 or widget 5-230 is selected is determined based on a number of factors. First, an object must be designed and placed in the repository by a component designer, allowing for use by other designers. Second, the object must be specified by an application designer as part of an application. During processing or execution of the application, the output composition processor will request the object in question (such as a component or wizard for example) from the services manager.

The request for the object may be expected to include information about the user who will use the object, the locale from which the user is making the request, the type of device the user is using to make the request, the environment in which the application is being executed for the user, and other factors as may be appropriate. Each object may then be expected to have a variety of attributes indicating what information matches to use of the object in question. Thus, the object may have various different aspects or instances, a first one of which is appropriate for a first set of circumstances or data whereas a second one of which is appropriate for a second set of circumstances or data.

In one example, a component may have a language associated with it, allowing for provision of data in a variety of languages depending on a user identity, locale, or other information. So, an unidentified user in Japan may receive a Japanese language instance of a component, while an identified French user in Japan may receive a French language instance of the component. Similarly, a component may have a display instance which varies by location, such that a user in Japan may see sushi where a user in the United States would see a hamburger. By processing the information received from the output composition processor, the services manager matches that information with attributes of the object and provides the proper instance of the object.

Typically, providing the object involves more than providing one java code fragment for example. Provision of a widget may involve providing the widget, including an XML state machine, a set of components used by the widget, and a set of data files accessed by the widget. Furthermore, the actual state machine, components of the set of components, and data files of the set of data files may be dictated by the data provided to the services manager. Thus, different data files may be provided for use on a PDA-style device than those data files provided either for use on a cell-phone style device or a desktop computer-style device. Similarly, different instances of components or state machines may be provided based on the data received. As the components, data files, and such are substituted into the java code fragments, the actual data provided may look substantially different after all of the substitution occurs.

Note that the instances of objects will have a set of attributes specified, and those attributes may be matched with the data provided as part of a request. In some cases, the object instance may be some form of a default instance suitable for use in any situation for which another instance has not been specified. Also, in some cases, some attributes may be specified, while other attributes are left unspecified, allowing for behavior along the lines of a wild-card or other attribute which matches a variety of specific information. All of this information may be specified by the creator of the object in question, thus allowing the designer of the object to provide something with predictable behavior that an application designer or interface designer may then manipulate.

Illustrated in FIG. 5-3 is a method of providing information for use in displaying a page. At block 5-310, a request for information (such as objects including components and wizards for example) is received. At block 5-320, a locale, user, device and other environment information is determined from the request. At block 5-330, appropriate widgets and components are found and provided in response to the request of block 5-310. The appropriate widgets and components may include default widget or component instances in situations where no instance exactly matches the information provided.

At block 5-340, a component tree is built, including the component instances and widget instances provided. At block 5-350, the component tree is processed into a page, and at block 5-360, the page is transmitted to a client device or otherwise displayed. Note that blocks 5-340, 5-350 and 5-360 correspond to processing of components or wizards after provision by the services manager, and illustrate the use of instances of objects once the objects are provided. In one embodiment, blocks 5-340, 5-350 and 5-360 are accomplished through use of a output composition processor for example.

Note that the instances described above may be templates into which other components or assets (data files for example) are substituted to create an actual object. Such flexibility requires control of changes to the repository, but also allows for enhancement of functionality and ease of change when modifying applications, objects (components for example) or even interfaces. It will be appreciated that matching the attributes of objects to the request for an object may be achieved in a variety of ways. However, providing objects which may be utilized in formation of web pages or applications in a dynamic manner based on such matching provides for flexibility in web pages and applications which synthesizes improvements made over time at the component, application, and interface levels without requiring constant interaction between designers working at the various levels.

### Integration

In one embodiment, a system as illustrated in FIG. 1-1 is provided. The output composition processor 1-100 is linked or coupled to a state engine 1-120, services manager 1-110 and security 1-130. Each of processor 1-100, engine 1-120, manager 1-1 10 and security 1-130 are coupled to the repository 1-150. Note that in one embodiment, all access to the repository 1-150 is through services manager 1-110, and access to services manager 1-110 is through output composition processor 1-100. Thus, links or couplings may be direct or indirect, and may require processing beyond a simple direct request.

An application for use with the system illustrated in FIG. 1-1 may be synthesized in a variety of ways. As illustrated in FIG. 1-2, independent design at various levels of abstraction may result in synthesis of design efforts without requiring constant communication by all designers. At block 1-210, the application is designed (or specified for example) by an application designer (this may be an architect or other high level designer for example). At block 1-220, independently, components are designed by component designers who may actually develop a variety of instances individually or provide a set of specifications to some form of builder (application) which then uses the specifications to populate a variety of instances of the given component.

At block 1-230, the interface for the application is designed independently of the rest of the design, taking into account what functionality may be available. Note that the interface may be designed as a single, one-size-fits-all interface, or may preferably be designed as a group of interfaces having some aspects in common but tailored to such different environments as different device capabilities or communications abilities for example. Thus, an interface may be specified in broad terms based on a PDA-type device and again based on a desktop computer-type device. Furthermore, some customization of the interface may occur based on what portions of the interface should or should not be dependent on factors such as available bandwidth, locale, specific user, or other information available at execution time. All of this information may be provided to a builder (application) which may be used to formalize the interface and determine what gaps need to be filled. Furthermore, the builder (any builder) may supply default values as appropriate, allowing for rapid prototyping.

At block 1-240, the application is built, utilizing the designs for the interface, the application, and the components. Building the application may involve creating a standalone prototype for testing purposes, or creating an application which may utilize the output composition manager to access information through the services manager in the repository, operate state machines through the state engine, and utilize incorporated security in the application and components. It will be appreciated that building the application may be accomplished, along with specifying the application, using UDDI, WSDL, SOAP and other well-known tools. Thus, the design and build process may be accomplished by users with only a simplistic knowledge of the underlying code or aspects of the components in question and the technology used to implement the application.

At block 1-250, the application may be further customized by a customer, such as specifying local default information or creating local interfaces which may be used by users accessing the application in a predetermined manner. This further customization will depend on what is made available in the way of customization features provided by component designers for example. Furthermore, it will be appreciated that specifying, building and designing components, applications and interfaces may all be accomplished in an iterative or parallel fashion. Additionally, it will be appreciated that using the high-level tools to manipulate components within the system described will allow for flexible assembly of useful and customized applications in a rapid and simple manner, allowing not only for rapid prototyping and ease of design, but rapid assembly of a variety of programs from the same basic set of components registered in a given repository.

At block 1-260, the application as created may be used by the intended users, resulting in use of the repository, running of state machines, and access control through security. This process may have an iterative context, in which designs for components, applications and interfaces may be changed based on availability of new assets, different products or data sources, innovations in design, or other changes, without requiring that the entire process be repeated. Thus, a new financial product may become available, resulting in modification of existing components. The modified components may be accessed and used by the application without requiring a new application or interface design.

In the foregoing detailed description, the method and apparatus of the present invention has been described with reference to specific exemplary embodiments thereof. It will, however, be evident that various modifications and changes may be made thereto without departing from the broader spirit and scope of the present invention. In particular, the separate blocks of the various block diagrams represent functional blocks of methods or apparatuses and are not necessarily indicative of physical or logical separations or of an order of operation inherent in the spirit and scope of the present invention. For example, the various blocks of FIG. 1-1 may be integrated into components, or may be subdivided into components. Similarly, the blocks of FIG. 1-2 (for example) represent portions of a method which, in some embodiments, may be reordered or may be organized in parallel rather than in a linear or step-wise fashion. The present specification and figures are accordingly to be regarded as illustrative rather than restrictive.

What is claimed is:

1. A method of designing a web application comprising:
designing a set of components, each component having a set of instances;
designing an application having references to the set of components;
designing an interface having references to the application; and
building the application based on the interface and the designing of the application.

2. The method of claim 1 wherein:
each components has a set of instances, each instance having a set of attributes related to use of the instance.

3. The method of claim 2 wherein:
the attributes relate to a locale and a specified identity of a user.

4. The method of claim 1 further comprising:
customizing the application based on local preferences.

5. The method of claim 1 further comprising:
customizing the application based on client preferences.

6. An apparatus comprising:
a output composition processor;
a services manager coupled to the output composition processor and coupled to a repository, the services manager to access the repository in response to requests from the output composition processor and to provide data from the repository to the output composition processor;
a state engine coupled to the output composition processor, the state engine to traverse state machines provided from the output composition processor; and
a security engine coupled to the output composition processor, the security engine to process requests for access and either grant or deny the requests based on security of the data from the repository and validation data provided from a user and wherein the output composition processor to respond to requests from a client by executing an application.

7. A machine-readable medium embodying instructions for execution by a processor, which, when executed by a processor, cause the processor to perform a method, the method comprising:
receiving a request for a web-based application;
accessing the web-based application;
accessing a set of objects related to the web-based application within a repository; and
executing the web-based application including the set of objects in a manner including interaction with a requestor originating the request for the web-based application.

8. The machine-readable medium of claim 7 further embodying instructions which, when executed by a processor, cause the processor to perform the method wherein:
receiving the request includes receiving a set of attributes including information specific to the request for the web-based application;
executing the web-based application includes managing a state machine through a state engine and allowing or denying state transitions based on security levels; and
accessing the set of objects includes determining which instances of each object of the set of objects match the set of attributes of the request.

9. A method of providing a web-based application comprising:
receiving a request for a web-based application;
accessing the web-based application;
accessing a set of objects related to the web-based application within a repository; and
executing the web-based application including the set of objects in a manner including interaction with a requestor originating the request for the web-based application.

10. The method of claim 9 wherein:
receiving the request includes receiving a set of attributes including information specific to the request for the web-based application;
executing the web-based application includes managing a state machine through a state engine and allowing or denying state transitions based on security levels; and
accessing the set of objects includes determining which instances of each object of the set of objects match the set of attributes of the request.

11. An apparatus comprising:
receiving means for receiving a request for a web-based application;
first accessing means for accessing the web-based application;
second accessing means for accessing a set of objects related to the web-based application within a repository; and
executing means for executing the web-based application including the set of objects including means for interacting with a requestor originating the request for the web-based application received by the receiving means, the executing means coupled to the receiving means, the executing means coupled to the first accessing means, the executing means coupled to the second accessing means.

12. An apparatus comprising:
a first logic block to receive a request for a web-based application;
a second logic block to access the web-based application from a repository;
a third logic block to access a set of objects related to the web-based application within the repository; and
a fourth logic block to execute the web-based application including the set of objects in a manner including interaction with a requestor originating the request for the web-based application.
